(19) United States
(12) Patent Application Publication
(10) Pub. No.: US 2014/0004944 A1
(43) Pub. Date: Jan. 2, 2014

(54) INTEGRATING ONLINE GAMES WITH ONLINE FEEDS

(71) Applicant: Zynga Inc., San Francisco, CA (US)

(72) Inventors: Daniel Chanho Lee, San Mateo, CA (US); Davin Anthony Seto, Navato, CA (US); Cedric Rhodes, San Francisco, CA (US); Arjun Bharat Lall, San Francisco, CA (US); Terri Tiongson, San Francisco, CA (US); Brian Edwin Fouts, San Francisco, CA (US); Abhinav Agrawal, San Francisco, CA (US); Raja Ramachandran, San Francisco, CA (US); Kushan Narendra Shah, San Francisco, CA (US)

(21) Appl. No.: 13/930,402

(22) Filed: Jun. 28, 2013

Related U.S. Application Data
(60) Provisional application No. 61/665,832, filed on Jun. 28, 2012.

(51) Int. Cl. A63F 13/12

(52) U.S. Cl. CPC A63F 13/12
USPC 463/31; 463/42

(57) ABSTRACT

Systems and methods for integrating online games with online feeds are described. In some example embodiments, the systems and methods receive an indication of a single action performed within an online game, identify two or more feeds external to the online game, and post information associated with the single action to the identified two or more feeds in response to the received indication.

### CROSS REFERENCE TO RELATED APPLICATIONS

This application claims priority to US. Provisional Patent Application No. 61/665,832, filed on Jun. 28, 2012, entitled SYSTEMS AND METHODS FOR INTEGRATING ONLINE GAMES WITH ONLINE FEEDS, which is hereby incorporated by reference in its entirety.

### FIELD

The present disclosure generally relates to integrating online games with online feeds.

### BACKGROUND

Conventional online games incentive players for a variety of things. For example, a game may reward players for achieving certain goals or levels, for winning a game, for bringing other players to the game, for performing tasks within a game, and so on. That is, in some cases, a provider of an online game seeks to increase the number of players going to and playing an online game, and provides various incentives that go along with a game in order to realize the increase in players and gaming time.

### BRIEF DESCRIPTION OF THE DRAWINGS

The example embodiments are illustrated by way of example, and not limitation, in the figures of the accompanying drawings, in which like reference numerals indicate the same or similar elements unless otherwise indicated.

FIG. 1 is a schematic diagram of a virtual gaming system, according to some example embodiments, in which feeds are integrated with online game.

FIG. 2 is a block diagram illustrating components of a feed posting engine, according to some example embodiments.

FIG. 3 is a flow diagram illustrating an example method for posting information to feeds integrated with an online game, according to some example embodiments.

FIG. 4 is a flow diagram illustrating an example method for configuring a feed item to a service supporting a feed, according to some example embodiments.

FIGS. 5A-5C are display diagrams illustrating example user interfaces that display the flow of posting feed items to multiple intergrated feeds based on a single action performed within an online game, according to some example embodiments.

FIGS. 6A-6B are display diagram illustrating example user interfaces for displayed feed items, according to some example embodiments.

FIG. 7 is a display diagram illustrating an example user interface for configuring a feed item, according to some example embodiments.

FIG. 8 shows a social network within a social graph that is integrated with a game network, according to some example embodiments.

FIG. 9 illustrates data flow between example components of the example system of FIG. 1.

FIG. 10 illustrates an example network environment in which various embodiments may operate.

FIG. 11 illustrates example computing system architecture, which may be used to implement one or more of the methodologies described herein.

### DESCRIPTION OF EXAMPLE EMBODIMENTS

### Overview

Systems and methods for integrating online games with online feeds are described. In some example embodiments, the systems and methods receive an indication of an action performed within an online game, identify two or more feeds external to the online game, and post information associated with the action to the identified two or more feeds in response to the received indication.

For example, the systems and methods may access and/or receive an indication that a player of an online game (e.g., a turn-based or social game) has reached a milestone or achievement (e.g., obtained a certain item, won a game or contest, and so on). The systems and methods may then select and/or identify different types of feeds at which to post information about the game and/or the achievement, such as feeds supported by a social network service, feeds supported by a micro-blog or other streaming information service, and so on. The systems and methods may then generate a feed item, optionally based on and/or configured for the selected feeds or supporting services, and post the feed items to the selected feeds, among other things.

Therefore, in some example embodiments, the systems and methods may receive an indication of an action performed within an online game that is associated with a player of the online game, select one or more feeds at which to post a feed item associated with the action performed within the online game, generate a feed item that is based on the action performed within the online game, and cause the generated feed item to be posted at the selected two or more feeds.

The systems and methods, therefore, may enable an online game to post feed items to various online locations associated with a player of the online game, facilitating an engagement between the game and various people associated with the player, such as other members of a shared social network service (e.g., Facebook, Google+, and so on), other users/members of a shared micro-blog (e.g., Twitter, Instagram, Vine, Tumblr), and/or other users/members of online locations that support and/or provide feeds and/or feed-based content, among other things.

These and other example embodiments are described, by way of example, in further detail below.

### Example Computing Environment

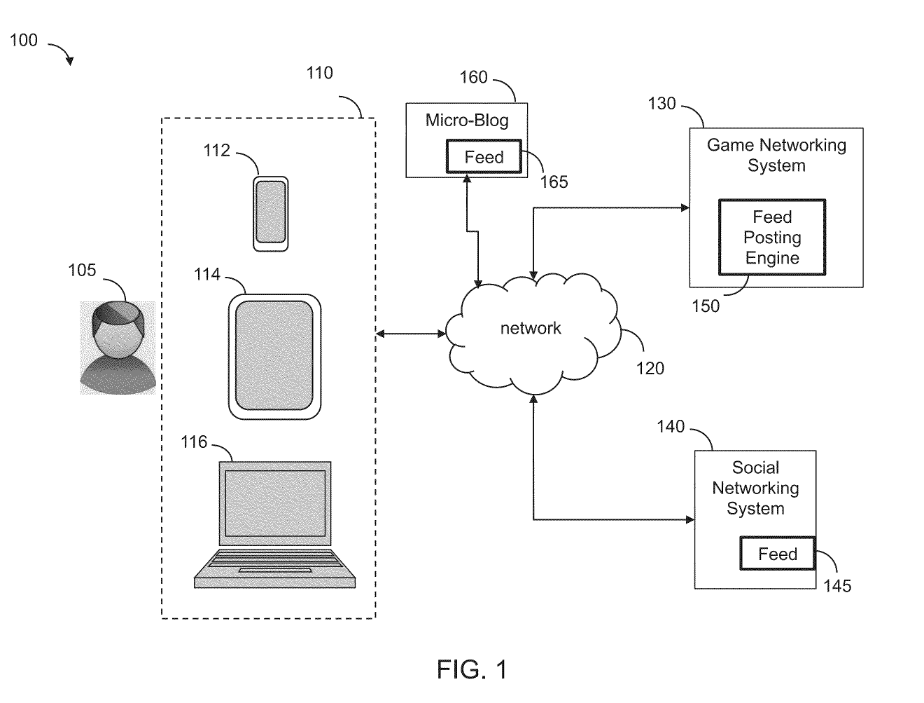

FIG. 1 shows a schematic diagram of a virtual gaming system 100, in accordance with some example embodiments, in which online games may integrate with online feeds. The system 100 may comprise a player 105 associated with a user device 110, a network 120, and a game networking system 130, along with a social networking system 140 supporting and/or providing one or more online feeds 145, and/or a micro-blog 160 supporting and/or providing one or more online feeds 165.

The example components of the system 100 may be connected directly or via the network 120, which may be any suitable network. In various example embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, any other type of network, or a combination of two or more such networks.

Although FIG. 1 illustrates a particular example of the arrangement of the player 105, the user device 110, the network 120, the game networking system 130, the social networking system 140, and the micro-blog 160, this disclosure includes any suitable arrangement or configuration of the player 105, the user device 110, the network 120, the game networking system 130, the social networking system 140, and the micro-blog 160.

The user device 110 may be any suitable computing device (e.g., devices 112-116), such as a smart phone 112, a tablet 114, a laptop 116, and/or any other device suitable for playing a virtual game, such as other mobile devices, gaming devices, computing devices, and so on. The user device 110 may access the social networking system 140 or the game networking system 130 directly, via the network 120, or via a third-party system. For example, the user device 110 may access the game networking system 130 via the social networking system 140, or vice versa. It should be noted that the functionality described herein may reside partially or wholly on any one device or be distributed across several devices.

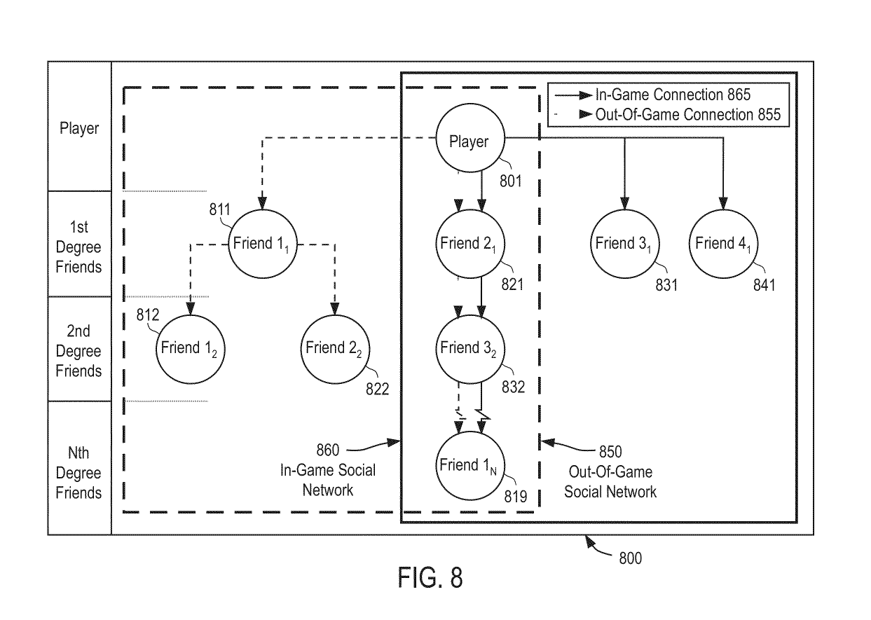

The social networking system 140 may include a network-addressable computing system that can host one or more social graphs (see, for example, FIG. 8), and may be accessed by the other components of the system 100 either directly or via the network 120. The social networking system 140 may generate, store, receive, and transmit social networking data.

In some example embodiments, the social network system 140, via a social network service may provide and/or support one or more feeds 145, such as streams of content accessible to members, viewers, and/or other users of the social network service. Similarly, the micro-blog 160 may provide and/or support one or more feeds 165, such as streams of content accessible to members, viewers, and/or other users of the micro-blog. In some cases, the social networking system 140 may provide a closed feed that is viewable and/or otherwise accessible to members of the social network service, while the micro-blog may provide an open feed that is viewable and/or otherwise accessible to both members and non-members of the micro-blog, among other things.

In some example embodiment, the game networking system 130 includes a feed posting engine 150 configured to post feed items associated with online games provided by the game networking system 130 to one or more feeds, such as the feed 145 supported by the social networking system 140, the feed 165 supported by the micro-blog 160, and so on.

The feed posting engine 150 may include various components, modules, and/or engines that cause external feeds (e.g., feed 145 and/or 165) to post feed items associated with actions performed within online games, such as actions within online games provided by the game networking system 130. For example, the feed posting engine 150 may receive and/or access indications or information associated with actions or events within online games that may trigger a post of a feed item or other information to a feed. Example events and/or performed actions include a player achievement within an online game (e.g., a player winning a game or contents, completing a quest, completing a puzzle or challenge, performing a certain game play action, reaching a game play metric, and so on).

In response to the action and/or event, the feed posting engine 150 may perform a variety of methods or processes in order to post, or cause to be posted, feed items associated with the online game (or, associated with the action and/or event), including identifying and/or selecting appropriate and/or suitable feeds at which to post feed items, generating the feed items and information contained by the feed items, configuring the feed items based on the services providing the feeds, and so on.

The feed posting engine 150, therefore, may enable an online game to post feed items, via a single action, to various online locations, such as social network services 130 (e.g., Facebook, Google+, and so on), micro-blogs 140 (e.g., Twitter, Instagram, Vine, Tumblr), and so on, facilitating an engagement between the game and users/members of such services, blogs, and other online locations that support and/or provide feeds and/or feed-based content, among other things.

Examples of Integrating Online Games with Online Feeds

As described herein, in some example embodiments, the systems and methods described herein enable an online game to post to multiple online feeds via a single action performed by the online game and/or by a player of the online game, among other things.

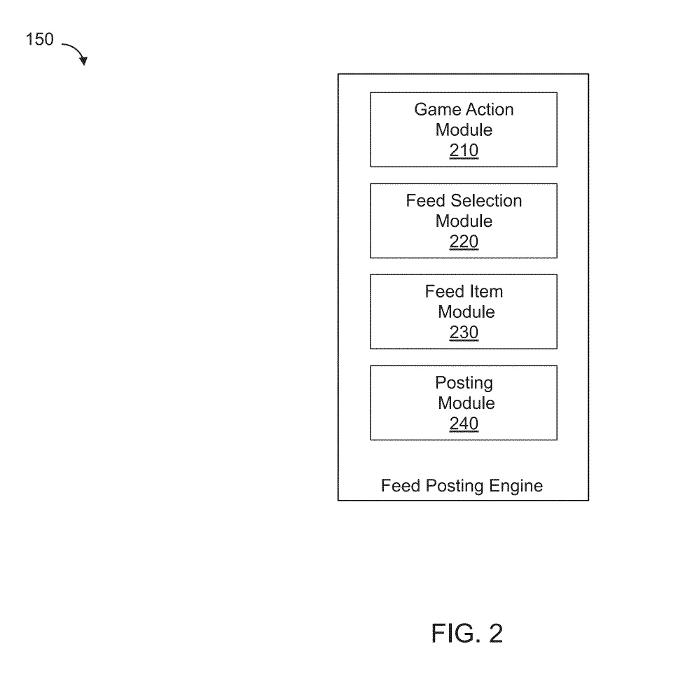

FIG. 2 is a block diagram illustrating components of the feed posting engine 150, according to some example embodiments. As illustrated in FIG. 2, the feed posting engine 150 includes a variety of functional modules. One skilled in the art will appreciate that the functional modules are implemented with a combination of software (e.g., executable instructions, or computer code) and hardware (e.g., at least a memory and processor). Accordingly, as used herein, in some example embodiments a module is a processor-implemented module and represents a computing device having a processor that is at least temporarily configured and/or programmed by executable instructions stored in memory to perform one or more of the particular functions that are described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a geographic location (e.g., within a home environment, an office environment, or a server farm). In other example embodiments, the one or more processors or processor-implemented modules may be distributed across a number of geographic locations.

Referring to FIG. 2, the feed posting engine 150 includes a game action 210, a feed selection module 220, a feed item module 230, and a posting module 240.

In some example embodiments, the game action module 210 is configured and/or programmed to receive an indication of an action performed within an online game that is associated with a player of the online game. For example, the game action module 210 may receive and/or access a trigger or other information (e.g., a trigger action) from an online game that indicates an action has been performed and/or an event has occurred within the online game, such as an indication of a player achievement, an indication of a player completing a quest, task, or challenge, an indication of an event associated with a group of players achieving a certain level of performance, an indication of an online game reaching a milestone (e.g., 1 million players currently playing, 1 billion games played, and so on), a player request to post a certain game status and/or achievement, and so on.

In some example embodiments, the feed selection module 220 is configured and/or programmed to select one or more feeds at which to post a feed item associated with the action performed within the online game. For example, the feed selection module 220 may select a feed supported by a social network service that includes a player that performed the action within the online game as a member, a feed supported by a micro-blog that includes the player as a member, a closed network of members that includes a player that performed the action within the online game as a member, a feed supported by an open network of users that includes the player as a user, and so on.

In some example embodiments, the feed selection module 220 may select a feed or feeds at which to post a feed item or other information based on a variety of factors and/or rules, including:

The type of feed item to be posted to the feed (e.g., the feed selection module 220 may select a social network supported feed for an award-based feed item, or a micro-blog supported feed for an advertisement feed item);

The type of action performed within the online game (e.g., the feed selection module 220 may select a social network supported feed for an achievement based action, or a micro-blog supported feed for a challenge completion based action);

The type or category of online game within which the action was performed (e.g., the feed selection module 220 may select a social network supported feed for actions performed within a social or social network based game, or a micro-blog supported feed for a turn-based game); and so on.

In some example embodiments, the feed item module 230 is configured and/or programmed to generate one or more feed items that are based on the action performed within the online game. For example, the feed item module 230 may generate a feed item that includes information associated with an online game and information associated with the player of the online game, and/or may generate and/or modify a feed item that includes information configured to a specification for feed items associated with a service at which to post the feed item that supports the feed. For example, the feed item module 230 may generate a feed item that includes a certain, or limited, number of characters, that includes a certain types of media (text, images, video, and so on), that includes links or other pointers, that includes information annotated (hashtags, @ symbols, and so on) for use within the feed, that is throttled or otherwise limited, and so on.

The feed item module 230, in some example embodiments, may also provide various mechanisms that facilitate the generation of feed items. For example, the feed item module 230 may automatically generate feed items, may automatically generate portions or aspects of feed items, may provide user interfaces that include preconfigured and/or user-selectable feed item options to be selected by a player for which a feed item is to be posted, and so on.

For example, the feed item module 230 may facilitate a player to automatically configure a feed using drop down menus and/or other user interfaces displaying user-selectable options. For example, a drop down menu (or, multiple menus) may provide a player with text that may be selected and inserted, in an automated fashion, into a feed (e.g., the micro-blog feed 65). When the feed is initiated from within an online game, the feed item module 230, via displayed drop down menus may display text, images, video, and/or other content that is related to and/or associated with the online game.

For example, the feed item module 230 may store a plurality of feed items as reference tweets (e.g., of less than or equal to 140 characters). The reference tweets may relate to activities or actions in an online game. A player may, for example, using a drop down menu, select one or more of the reference tweets for inclusion in the feed 165 of the micro-blog 160. Each of the reference tweets may be configured to conform with a specification of the micro-blog, such as configured to include hash tags (# tags). For example, a reference tweet may follow a certain syntax, such as:

“user provided text, #nameofgame,” or

“automatically generated text, link, #nameofgame, #currentreward,” or

“user provided text, link, #rewardcampaign,” among other things.

In some example embodiments, the feed item module 230 may provide both player-customized and game-defined reference tweets, which may differ from one game type to another, as described herein. For example, an online social game (e.g., FarmVille) may have messages that relate to specific activities or actions within the social game, whereas an online turn-based game (e.g., Words With Friends) may have message that relate to certain achievements within the online game, among other things.

In some example embodiments, the posting module 240 is configured and/or programmed to cause the generated one or more feed items to be posted at the selected one or more feeds. For example, the posting module 240 may access one or more selected feeds, via APIs provided by the services supporting the feeds, and cause the feed to post the generated feed items, among other things.

In some example embodiments, the posting module 240 may be configured to authorize and/or set up the player with the social network service 140 and/or micro-blog 160, in order to facilitate posting game-based information to supported feeds 145 or 165, respectively. For example, when a player is not logged into the service providing the feeds, the posting module 240 may present one or more interfaces configured to receive credentials from the player (e.g., username and password) and/or extract the credentials from another computing resource, such as an application for the service that is downloaded to the player's user device 110.

In some example embodiments, when a player forgets or does not have access credentials, the posting module 240 may facilitate the acquisition and/or retrieval of the credentials withouth transferring the player out of a current game environment.

For example, when a player forgets a password associated with the micro-blog 160 and receives an email from the micro-blog to resolve the issue, the posting module 240 may embed an indicator into an email addressing the password issue, the indicator identifying that the game (e.g., a turn-based game) originally sent the user to the micro-blog 160 when attempting to post to the feed 165 supported by the micro-blog. Thereafter, once the user has successfully resolved the forgotten password issue, the micro-blog may send a token identifying the player (e.g., identifying the player using his or her game credentials), and the player may then automatically connect to the micro-blog's API and complete the feed post. Thus, the posting module 240 may facilitate the tracking of the movement's of the player as he/she retrieves a password and is authorized to the micro-blog 160, and resume the flow of posting game information to the feed 165 of the micro-blog 160 without the player leaving the game environment, among other things.

As described herein, in some example embodiments, the feed posting engine 150 may facilitate the posting of feed items that includes links and information associated with viewers of the feed items redeeming rewards in response to viewing and interacting with the feed items, among other things. In these embodiments, the feed posting engine 150 may facilitate the bi-directional functionality of feeds and feed items, among other things. The feed posting engine 150 may provide a closed loop functionality for feeds, where a user interaction with a feed or feed item is monitored and mapped back to an online game. For example, when a feed item originates from an action within a certain online game, an interaction with the feed by a viewer or other user of the feed may result in a game installation, an in-game award, and so on for the viewer, and the online game may monitor the installation, award, and so on.

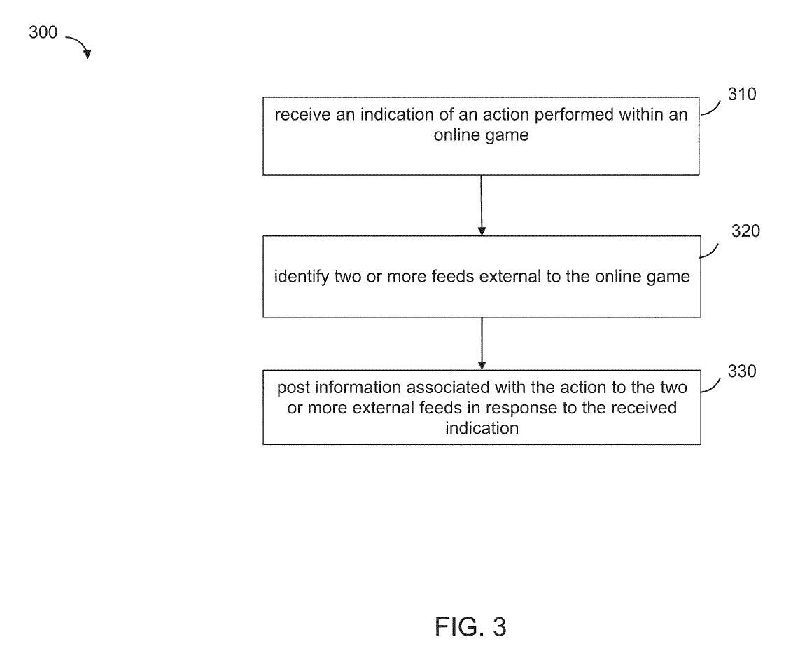

As described herein, the feed posting engine 150 may perform various different processes and/or methods when integrating online games with online feeds, among other things. FIG. 3 is a flow diagram illustrating an example method 300 for posting information to feeds integrated with an online game, according to some example embodiments. The method 300 may be performed by the feed posting engine 150 and, accordingly, is described herein merely by way of reference thereto. It will be appreciated that the method 300 may be performed on any suitable hardware.

In operation 310, the feed posting engine 150 receives an indication of an action performed within an online game. For example, the game action module 210 may receive and/or access a trigger or other information from an online game that indicates an action has been performed and/or an event has occurred within the online game, such as an indication of a player achievement, an indication of a player completing a quest, task, or challenge, an indication of an event associated with a group of players achieveing a certain level of performance, an indication of an online game reaching a milestone (e.g., 1 million players currently playing, 1 billion games played, and so on), a player request to post a certain game status and/or achievement, and so on.

In operation 320, the feed posting engine 150 identifies two or more feeds external to the online game, such as feeds located outside of the online game and/or located on or within a platform that is external or otherwise different from a platform hosting the online game. For example, the feed selection module 220 may select a feed supported by a social network service that includes a player that performed the action within the online game as a member, a feed supported by a micro-blog that includes the player as a member, a feed supported by a closed network of members that includes a player that performed the action within the online game as a member, a feed supported by an open network of users that includes the player as a user, and so on.

In some example embodiments, the feed selection module 220 may select two or more feeds external to the online game based on the action performed within the online game, based on the online game, based on the type of information to be posted, and so on.

In operation 330, the feed posting engine 150 posts information associated with the action to the identified two or more feeds in response to the received indication. For example, the posting module 240 may access two or more selected feeds, via APIs provided by the services supporting the feeds, and cause the feeds to post generated feed items and/or other information. The posting module 240 may automatically post information to the identified two or more feeds on behalf of the player in response to the action being performed within the online game, in response to a request received from the player to post the information to the identified two or more feeds, and so on.

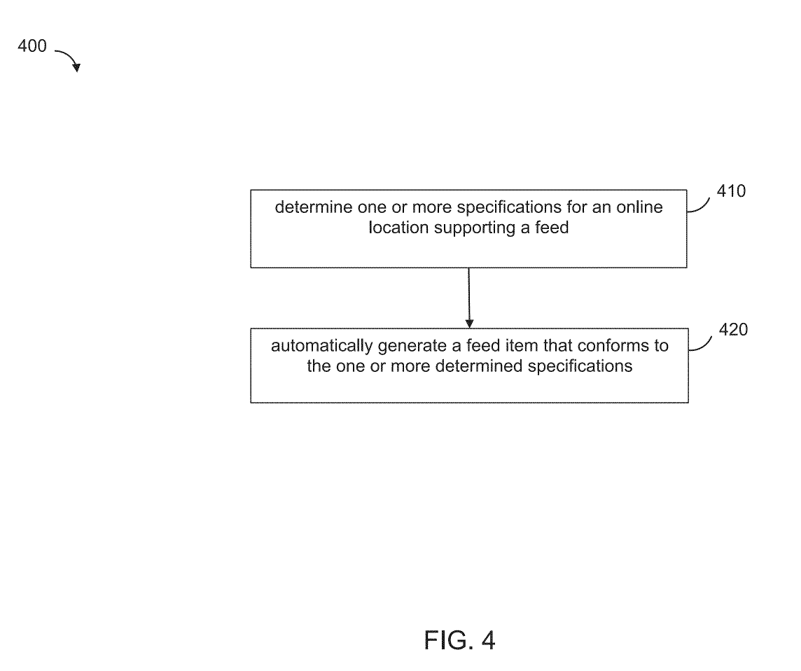

In some example embodiments, the posting module 240 may utilize the feed item module 230 to generate feed items to be posted at feeds, such as feeds 145 and/or 165. For example, the feed item module 230 may generate feed items that are appropriate for the feed at which the items are to be posted. FIG. 4 is a flow diagram illustrating an example method 400 for configuring a feed item to a service supporting a feed, according to some example embodiments. The method 400 may be performed by the feed posting engine 150 and, accordingly, is described herein merely by way of reference thereto. It will be appreciated that the method 400 may be performed on any suitable hardware.

In operation 410, the feed posting engine 150 determines one or more specifications for an online location supporting a feed. For example, the feed posting engine 150 determines parameters and/or rules associated with a syntax of feed items to be posted at the online location, such as various parameters for a social network service (e.g., types of media to be posted, authorized viewers of the feed item), for a micro-blog (e.g., character limits for text, size or duration limits for images, videos, GIFs, and so on), and so on.

In operation 420, the feed posting engine 420 automatically generates a feed item that conforms to the one or more determine specifications. For example, the feed item module 230 may generate different feed items for different target feeds based on a single action within an online game and having similar messaging, information, links, and/or other content associated with the action and/or the online game. The posting module 240 may then automatically post the feed item to the feed (e.g, feed 145 and/or feed 165) on behalf of the player in response to the action being performed within the online game.

As described herein, in some example embodiments, the posting module 240 may feed items and/or information having a variety of different types of content, such as feed items that include a link to a user-redeemable reward within the online game, feed items that include a link to a downloadable version of the online game, feed items that include advertising content for the online game, and so on.

In some example embodiments, the posting module 240 may post certain feed items to feeds, based on a variety of factors. For example, the posting module 240 may:

Post a first feed item that includes a link to a user-redeemable reward within the online game to a first feed that is supported by a social network service that includes a player that performed the action within the online game as a member and post a second feed item that includes a link to access the online game to a second feed that is supported by a micro-blog that supported by a micro-blog that includes a player that performed the action within the online game as a member,

Post a first feed item that includes a link to a first user-redeemable reward within the online game to a first feed that is supported by a social network service that includes a player that performed the action within the online game as a member, the user-redeemable reward being redeemable by a capped number of members of the social network service and post a second feed item that includes a link to a second user-redeemable reward within the online game to a second feed that is supported by a micro-blog that includes a player that performed the action within the online game as a member, the user-redeemable reward being redeemable by an unlimited number of members of the micro-blog,

Post a first feed item that includes a link to a first user-redeemable reward within the online game to a first feed that is supported by a social network service that includes a player that performed the action within the online game as a member and post a second feed item that includes an advertisement for the online game to a second feed that is supported by a micro-blog that includes a player that performed the action within the online game as a member, and so on.

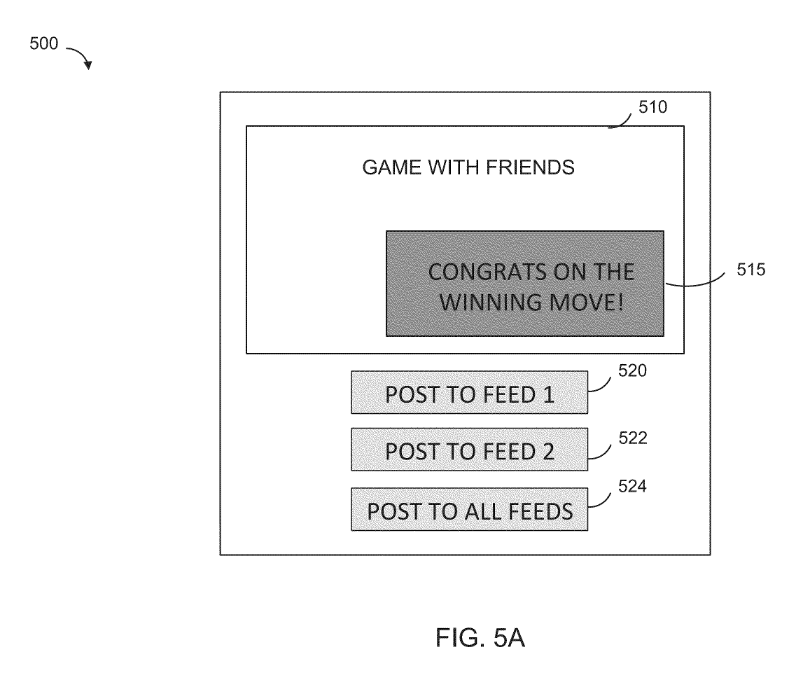

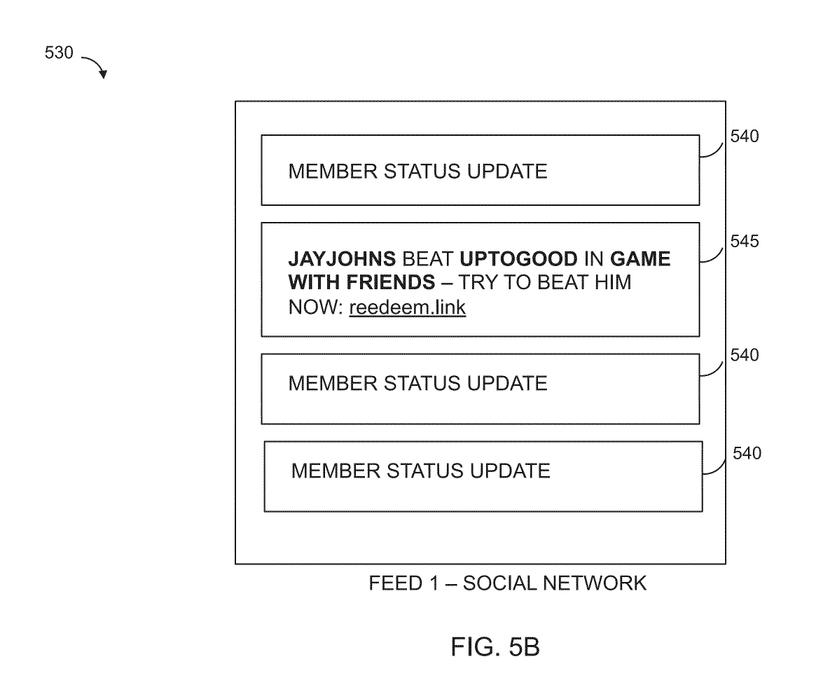

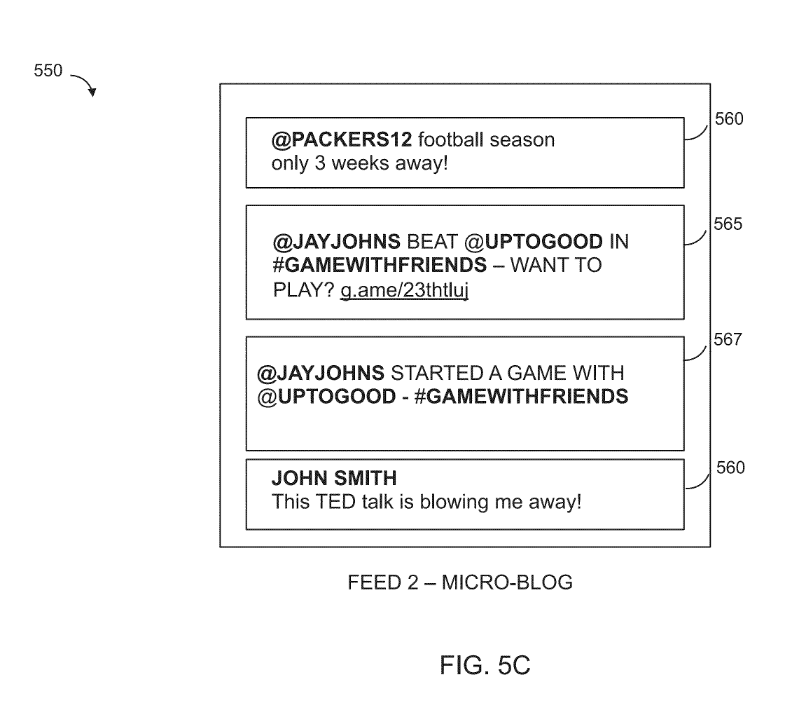

Therefore, in some example embodiments, the feed posting engine 150, via the posting module 240, may post a variety of different feed items having different content contained within the feed items, in different configurations based on the feeds (or, supporting service) at which the feed items are posted, among other things. FIGS. 5A-5C are display diagrams illustrating example user interfaces that display the flow of posting feed items to multiple intergrated feeds based on a single action performed within an online game, according to some example embodiments.

FIG. 5A depicts a user interface 500 displaying a game environment 510 for an online game “Game With Friends” that a player is currently playing. The player reaches a certain achievement within the game (e.g., wins a game played against another player), and the game display a graphical element 515 indicating the win, along with user-selectable elements 520-524 that are configured to, via a single selection of one or more of the user-selectable elements, post to a first feed 520, post to a second feed 522, and/or post to multiple feeds 524.

Upon receiving a selection of user-selectable element 524, indicating a player request to post a feed item to all feeds in response to the player winning the game, the feed posting engine 150 posts a feed item to the feed 145 supported by the social network service 140 (depicted in FIG. 5B) and a feed item to the feed 165 supported by the micro-blog (depicted in FIG. 5C).

For example, FIG. 5B depicts the posting of a feed item 545 associated with the game action represented by graphical element 515 within a feed 530, or timeline or other content stream, of a social network service (e.g., Facebook, Google+, and so on). The feed 530 includes other feed or timeline elements for a member of the social network service, such as status updates 540, as well as the feed item 545, which is posted to the feed 530 in response to the player winning the game within the game environment and selecting user-selectable element 524 (or, element 520), to post a feed item to multiple feeds. The feed posting engine 150 may utilize some or all of the techniques described herein when generating and/or posting the feed item 545. For example, the feed posting engine 150 generates the feed item 545 to include a link to a reward that, when selected by a viewer of the feed (e.g., a connection to the player within the social network service), enables the viewer selecting the link to redeed a reward within the online game environment 510, among other content.

As another example, FIG. 5C depicts the posting of a feed item 565 associated with the game action represented by graphical element 515 within a feed 550 or other content stream of a micro-blog (e.g., Twitter, Instagram, and so on). The feed 550 includes other feed or timeline elements for a member of the social network service, such as other posts or tweets 560, a previous feed item 567 associated with the online game, as well as the feed item 565, which is posted to the feed 550 in response to the player winning the game within the game environment and selecting user-selectable element 524 (or, element 522), to post a feed item to multiple feeds. The feed posting engine 150 may utilize some or all of the techniques described herein when generating and/or posting the feed item 565. For example, the feed posting engine 150 generates the feed item 565 to include a link to the online game that, when selected by a viewer of the feed (e.g., a user of the micro-blog), enables the viewer selecting the link to download or otherwise access the online game providing the online game environment 510, among other content.

Thus, in some example embodiments, the feed posting engine 150 facilitates multiple feed item postings in response to a single game action within an online game and/or single request from a player of the online game, such as feed item postings to a social network service, a micro-blog, or other online locations that support content feeds.

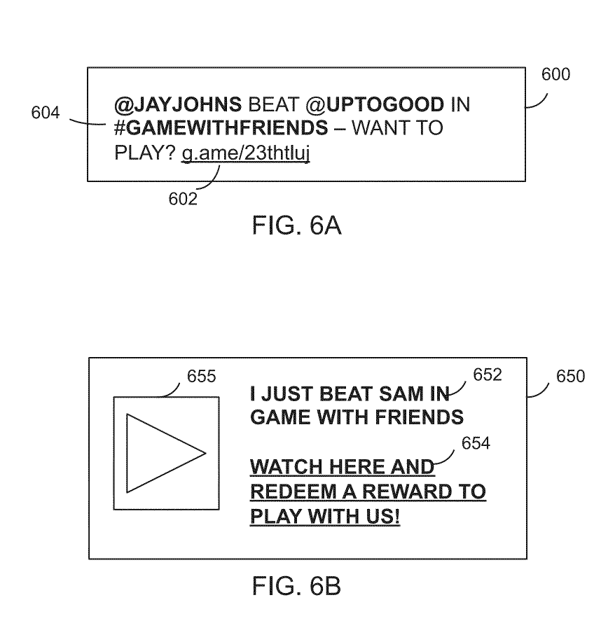

As described herein, the feed posting engine 150 may modify or otherwise generate feed items configured for use within specific feeds and/or hosting environments supporting the feeds, among other things. For example, FIG. 6A depicts a feed item 600 configured to be displayed within a text-based, character-constrained micro-blog 160, such as Twitter. The feed item 600 includes textual content having less than 140 characters, a shortened link 602 to the online game, and a phrase 604 that includes a metadata tag (#), which may group and/or categorize the tweet to other similar tweets posted to the micro-blog.

As another example, FIG. 6B depicts a feed item 650 configured to be displayed within a social network based feed 140, such as timeline within Facebook. The feed item 650 includes textual content 652, a link 654 to a redeemable reward associated with the online game, and a short video 655 captured from the online game, such as a short video of a winning move within the online game. Of course, one of ordinary skill will realize that the feed posting engine 150 may generate and/or post other feed items, such as feed items having various different configurations and having various types of content, among other things.

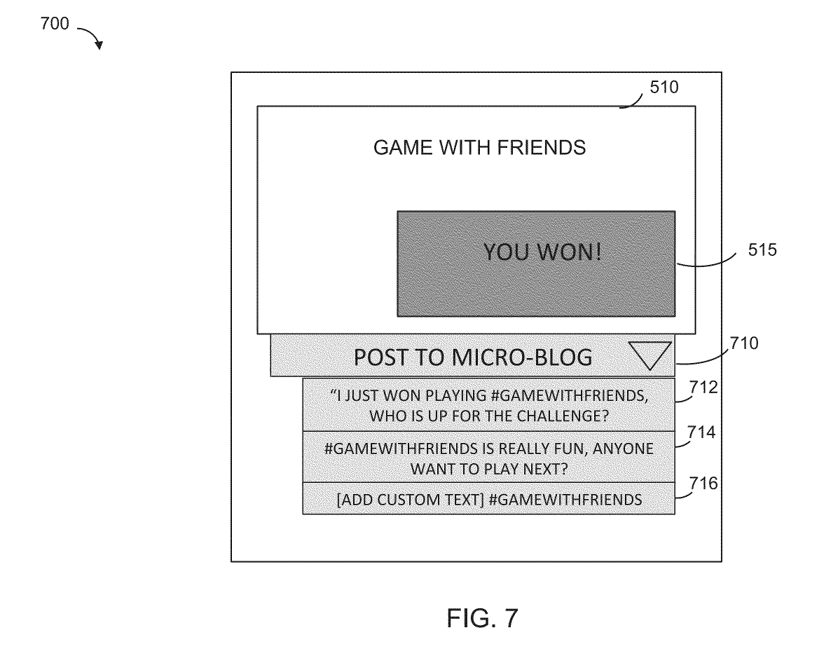

As described herein, in some example embodiments, the feed posting engine 150 may provide a player with various user interfaces configured to facilitate the generation, selection, and/or posting of feed items in response to actions or events within an online game. FIG. 7 is a display diagram illustrating an example user interface 700 for configuring a feed item, according to some example embodiments. The user interface 700 depicts the game environment 510 of FIG. 5A, and displays a drop down menu 710 that, when selected (e.g., clicked) by a user, presents different user-selectable options 712-716 for messages to be presented within a feed item associated with the online game. For example, upon receiving a user selection of option 714, the feed posting engine 150 generates a feed item having a message of “#GAMEWITHFRIENDS IS REALLY FUN, ANYONE WANT TO PLAY NEXT,” and posts the feed item to the feed 165 of the micro-blog 160 and to the feed 145 of the social network service 140, among other locations.

Thus, in some example embodiments, the feed posting engine 150 enables an online game to post feed items to various online locations associated with a player of the online game, facilitating an engagement between the game and various people associated with the player, such as other members of a shared social network service (e.g., Facebook, Google+, and so on), other users/members of a shared micro-blog (e.g., Twitter, Instagram, Vine, Tumblr), and/or other users/members of online locations that support and/or provide feeds and/or feed-based content, among other things.

### Example Game Systems, Social Networks, and Social Graphs

FIG. 8 shows an example of a social network within a social graph 800. In example embodiments, a virtual landscape or environment of a player may be visible to other players of the virtual game. In an example embodiment. Data from the social graph is included in the user profile data (or added thereto) to allow configuration of virtual scratch cards based on social network data.

The social graph 800 is shown by way of example to include an out-of-game social network 850 and an in-game social network 860. Moreover, the in-game social network 860 may include one or more players that are friends with the User 801 (e.g., a Friend 831), and may include one or more other users that are not friends with the User 801. The social graph 800 may correspond to the various users associated with the virtual game.

As described above, the example systems described herein may include, communicate, or otherwise interact with a game system. As such, a game system is now described to illustrate further example embodiments. In an online multiuser game, users control player characters (PCs), a game engine controls non-player characters (NPCs); the game engine also manages player character state and tracks states for currently active (e.g., online) users and currently inactive (e.g., offline) users. A game engine, in some embodiments, may include a documentation engine. Alternatively, the documentation engine and game engine may be embodied as separate components operated by the game network system and/or the document provision system.

A player character may have a set of attributes and a set of friends associated with the player character. As used herein, the terms “state” and “attribute” can be used interchangeably to refer to any in-game characteristic of a player character, such as location, assets (e.g., value icons), levels, condition, health, status, inventory, skill set, name, orientation, affiliation, specialty, and so on. The game engine may use a player character state to determine the outcome of a game event, while sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights, and/or benefits or the obtaining of some assets (e.g., health, money (e.g., virtual currency from a value icon), strength, inventory, land, etc.). A game engine may determine the outcome of a game event according to game rules (e.g., “a character with less than 5 health points will be prevented from initiating an attack”), based on a character's state, and also possibly on interactions of other player characters and a random calculation. Moreover, an engagement may include simple tasks (e.g., cross the river, shoot at an opponent, interact with a value icon, or the like), complex tasks (e.g., win a battle, unlock a puzzle, build a factory, rob a liquor store), or other events. These tasks and other events may form part (or supplement) the user profile data and thus be taken into account when configuring a scratch card. Selecting an award based on these events and tasks may enhance the likelihood that a player will enjoy and subsequently rengage with the virtual game.

In a game system according to some aspects of the present disclosure, in determining the outcome of a game event in a game being played by a user (or a group of more than one users), the game engine may take into account the state of the player character (or group of PCs) that is playing, but also the state of one or more PCs of offline/inactive users who are connected to the current user (or PC, or group of PCs) through the game social graph but are not necessarily involved in the game at the time.

For example, a User A with six friends on User A's team (e.g., the friends that are listed, depending on the nature of the game, as being in the user's mob/gang/set/army/business/crew/etc.) may be playing the virtual game and choose to confront a User B who has 20 friends on User B's team. In some embodiments, a user may only have first-degree friends on the user's team. In other embodiments, a user may also have second-degree and higher degree friends on the user's team. To resolve the game event, in some embodiments, the game engine may total up the weapon strength of the seven members of the User A's team and the weapon strength of the 21 members of the User B's team and decide an outcome of the confrontation based on a random variable applied to a probability distribution that favors the side with the greater total. In some embodiments, all of this may be done without any other current active participants other than the User A (e.g., the User A's friends, the User B, and the User B's friends could all be offline or inactive). In some embodiments, the friends in a user's team may see a change in their state as part of the outcome of the game event. In some embodiments, the state (assets, condition, level) of friends beyond the first degree are taken into account. One or more players may be presented with virtual scratch cards to potentially win one or more of these assets, conditions, levels etc.

A virtual game may be hosted by the game networking system 130, which can be accessed using any suitable connection 120 with a suitable user device 110. A user may have a game account on the game networking system 130, wherein the game account may contain a variety of information associated with the user (e.g., the user's personal information, financial information, purchase history (e.g., of in-game assets), player character state, game state, or any other user profile data). In some embodiments, a user may play multiple games on the game networking system 130, which may maintain a single game account for the user with respect to the multiple games, or multiple individual game accounts for each game with respect to the user. In an example embodiment, virtual currency awarded by a scratch card may be used across multiple games. In some embodiments, the game networking system 130 may assign a unique identifier to a player 105 of a virtual game hosted on the game networking system 130. The game networking system 130 may determine that the player 105 is accessing the virtual game by reading the user's cookies, which may be appended to HTTP requests transmitted by the user device 110, and/or by the player 105 logging onto the virtual game.

In some embodiments, the player 105 accesses a virtual game and controls the game's progress via the user device 110 (e.g., by inputting commands to the game at the user device 110). The user device 110 can display the game interface, receive inputs from the player 105, transmit user inputs or other events to the game engine, and receive instructions from the game engine. The game engine can be executed on any suitable system (such as, for example, the user device 110, the social networking system 140, or the game networking system 130). For example, the user device 110 may download client components of a virtual game, which are executed locally, while a remote game server, such as the game networking system 130, provides backend support for the client components and may be responsible for maintaining application data of the game, processing the inputs from the player 105, updating and/or synchronizing the game state based on the game logic and each input from the player 105, and transmitting instructions to the user device 110. As another example, when the player 105 provides an input to the game through the user device 110 (such as, for example, by typing on the keyboard, clicking the mouse, or interacting with a touch screen of the user device 104), the client components of the game may transmit the user's input to the game networking system 130.

In some embodiments, the player 105 accesses particular game instances of a virtual game. A game instance is a copy of a specific game play area that is created during runtime. In some embodiments, a game instance is a discrete game play area where one or more players 105 can interact in synchronous or asynchronous play. A game instance may be, for example, a level, zone, area, region, location, virtual space, or other suitable play area. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more in-game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of in-game actions available to a specific user is different in a game instance that is associated with this user compared to a game instance that is not associated with this user. The set of in-game actions available to a specific user in a game instance associated with this user may be a subset, superset, or independent of the set of in-game actions available to this user in a game instance that is not associated with him. For example, a first user may be associated with Blackacre Farm in an online farming game and may be able to plant crops on Blackacre Farm. If the first user accesses a game instance associated with another user, such as Whiteacre Farm, the game engine may not allow the first user to plant crops in that game instance. However, other in-game actions may be available to the first user, such as watering or fertilizing crops on Whiteacre Farm. Likewise, a value icons may have restrictions.

In some embodiments, a game engine interfaces with a social graph (e.g., to obtain user profile data from the social graph to, inter alia, configure the virtual sctach cards). Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the game networking system 130, which is managed by the game operator. In other embodiments, the social graph is part of a social networking system or service 140 managed by a third party (e.g., Facebook, Friendster, Myspace, Google+). In yet other embodiments, the player 105 has a social network on both the game networking system 130 and the social networking system 140, wherein the player 105 can have a social network on the game networking system 130 that is a subset, superset, or independent of the user's social network on the social networking system 140. In such combined systems, game network system 108.2 can maintain social graph information with edge-type attributes that indicate whether a given friend is an “in-game friend,” an “out-of-game friend,” or both. The various embodiments disclosed herein are operable when the social graph is managed by the social networking system 130, the game networking system 140, or both.

Returning to FIG. 8, the User 801 may be associated, connected, or linked to various other users, or “friends,” within the out-of-game social network 850. These associations, connections, or links can track relationships between users within the out-of-game social network 850 and are commonly referred to as online “friends” or “friendships” between users. Each friend or friendship in a particular user's social network within a social graph is commonly referred to as a “node.” For purposes of illustration, the details of out-of-game social network 850 are described in relation to User 801. As used herein, the terms “user” and “player” can be used interchangeably and can refer to any user in an online multiuser game system or social networking system. As used herein, the term “friend” can mean any node within a user's social network.

As shown in FIG. 8, User 801 has direct connections with several friends. When the User 801 has a direct connection with another individual, that connection is referred to as a first-degree friend. In out-of-game social network 850, the User 801 has two first-degree friends. That is, the User 801 is directly connected to Friend 1₁ 811 and Friend 2₁ 821. In social graph 800, it is possible for individuals to be connected to other individuals through their first-degree friends (e.g., friends of friends). As described above, the number of edges in a minimum path that connects a user to another user is considered the degree of separation. For example, FIG. 8 shows that User 801 has three second-degree friends to which User 801 is connected via User 801's connection to User 801's first-degree friends. Second-degree Friend 1₂ 812 and Friend 2₂ 822 are connected to User 801 via User 801's first-degree Friend 1₁ 811. The limit on the depth of friend connections, or the number of degrees of separation for associations, that User 801 is allowed is typically dictated by the restrictions and policies implemented by the social networking system 140.

In various embodiments, User 801 can have Nth-degree friends connected to him through a chain of intermediary degree friends as indicated in FIG. 8. For example, Nth-degree Friend 1_{N} 819 is connected to User 801 within in-game social network 860 via second-degree Friend 3₂ 832 and one or more other higher-degree friends.

In some embodiments, a user (or player/player character) has a social graph within an online multiuser game that is maintained by the game engine and another social graph maintained by a separate social networking system. FIG. 8 depicts an example of in-game social network 860 and out-of-game social network 850. In this example, User 801 has out-of-game connections 855 to a plurality of friends, forming out-of-game social network 850. Here, Friend 1₁ 811 and Friend 2₁ 821 are first-degree friends with User 801 in User 801's out-of-game social network 850. User 801 also has in-game connections 865 to a plurality of users, forming in-game social network 860. Here, Friend 2₁ 821, Friend 8₁ 831, and Friend 4₁ 841 are first-degree friends with User 801 in User 801's in-game social network 860. In some embodiments, a game engine can access in-game social network 860, out-of-game social network 850, or both.

In some embodiments, the connections in a user's in-game social network are formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that could be the case.

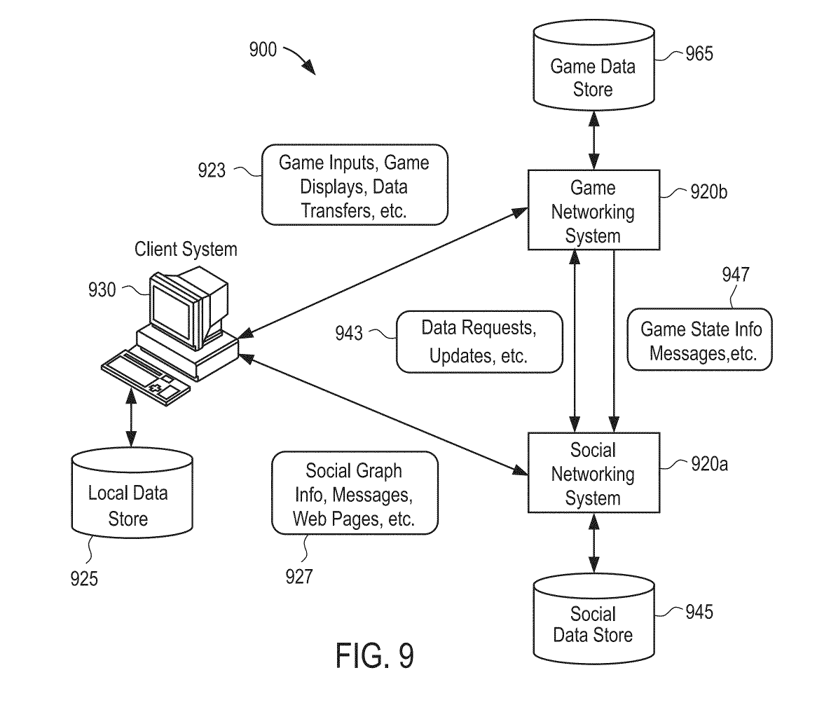

FIG. 9 shows an example data flow between example components of an example system 900. One or more of the components of the example system 900 may correspond to one or more of the components of the example system 100. In some embodiments, system 900 includes a client system 930, a social networking system 920a, and a game networking system 920b. The components of system 900 can be connected to each other in any suitable configuration, using any suitable type of connection. The components may be connected directly or over any suitable network. The client system 930, the social networking system 920a, and the game networking system 920b may have one or more corresponding data stores, such as the local data store 925, the social data store 945, and the game data store 965, respectively.

The client system 930 may receive and transmit data 923 to and from the game networking system 920b. This data can include, for example, a web page, a message, a game input, a game display, a HTTP packet, a data request, transaction information, and other suitable data. At some other time, or at the same time, the game networking system 920b may communicate data 943, 947 (e.g., game state information, game system account information, page info, messages, data requests, updates, etc.) with other networking systems, such as the social networking system 920a (e.g., Facebook, Myspace, etc.). The client system 930 can also receive and transmit data 927 to and from the social networking system 920a. This data can include, for example, web pages, messages, social graph information, social network displays, HTTP packets, data requests, transaction information, updates, and other suitable data.

Communication between the client system 930, the social networking system 920a, and the game networking system 920b can occur over any appropriate electronic communication medium or network using any suitable communication protocol. For example, the client system 930, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the game networking system 920b, the BLOB containing the game state for the instance corresponding to the user may be transmitted to the client system 930 for use by a client-side executed object to process. In some embodiments, the client-side executable is a FLASH-based game, which can de-serialize the game state data in the BLOB. As a user plays the game, the game logic implemented at the client system 930 maintains and modifies the various game state parameters locally. The client-side game logic may also batch game events, such as mouse clicks, and transmit these events to the game networking system 920b. Game networking system 920b may itself operate by retrieving a copy of the BLOB from a database or an intermediate memory cache (memcache) layer. The game networking system 920b can also de-serialize the BLOB to resolve the game state parameters and execute its own game logic based on the events in the batch file of events transmitted by the client to synchronize the game state on the server side. The game networking system 920b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 930. For example, a client application downloaded to the client system 930 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages are associated with or accessed by the social networking system 920a. This disclosure contemplates using any suitable application for the retrieval and rendering of structured documents hosted by any suitable network-addressable resource or website.

Application event data of a game is any data relevant to the game (e.g., user inputs or interations). In some embodiments, each application datum may have a name and a value, and the value of the application datum may change (e.g., be updated) at any time. When an update to an application datum occurs at the client system 930, either caused by an action of a game user or by the game logic itself, the client system 930 may need to inform the game networking system 920b of the update. For example, if the game is a farming game with a harvest mechanic (such as FarmVille by Zynga), an event can correspond to a user clicking on a parcel of land to harvest a crop. In such an instance, the application event data may identify an event or action (e.g., harvest, payment of virtual currency from a winning scratch card game, or the like) and an object in the game to which the event or action applies. This and other data may form part of the user profile data to configure the virtual scratch cards.

In some embodiments, one or more objects of a game are represented as an Adobe Flash object. Flash may manipulate vector and raster graphics, and supports bidirectional streaming of audio and video. “Flash” may mean the authoring environment, the user, or the application files. In some embodiments, the client system 930 may include a Flash client. The Flash client may be configured to receive and run a Flash application or game object code from any suitable networking system (such as, for example, the social networking system 920a or the game networking system 920b). In some embodiments, the Flash client is run in a browser client executed on the client system 930. A user can interact with Flash objects using the client system 930 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object (e.g., defining portions of the scratch card 202) that represents a particular in-game object. For example, a user can interact with a Flash object to use, move, rotate, delete, scratch, attack, shoot, redeem virtual currency from a value object, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 930, the Flash client may send the events that caused the game state changes to the in-game object to the game networking system 920b. However, to expedite the processing and, hence, the speed of the overall gaming experience, the Flash client may collect a batch of some number of events or updates into a batch file. The number of events or updates may be determined by the Flash client dynamically or determined by the game networking system 920b based on server loads or other factors. For example, client system 930 may send a batch file to the game networking system 920b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. The user profile data may include application event data. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 930, the game networking system 920b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, game networking system 920b may retrieve the corresponding BLOB from the database to determine the most-recent values of the game-related data. In some embodiments, while a user is playing the virtual game, the game networking system 920b also loads the corresponding BLOB into a memory cache so that the game system may have faster access to the BLOB and the game-related data contained therein.

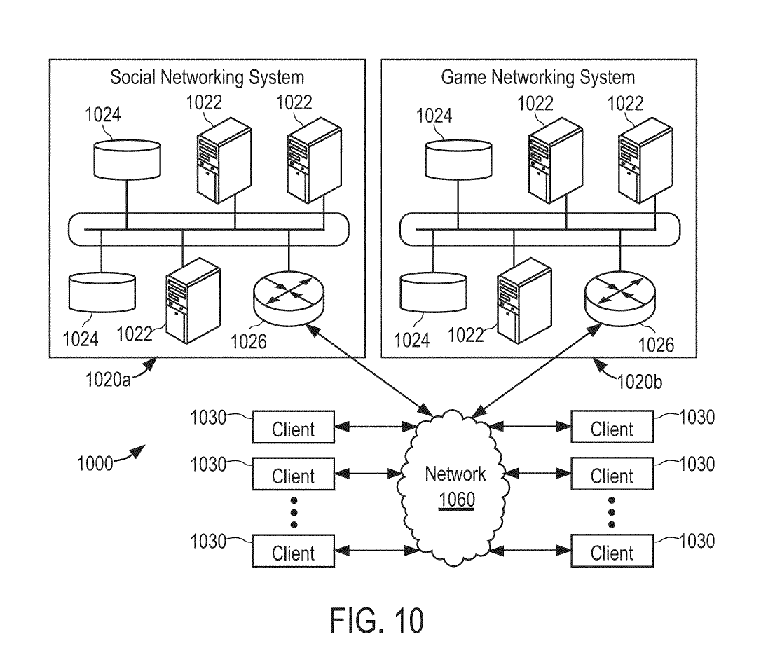

Various embodiments may operate in a WAN environment, such as the Internet, including multiple network addressable systems. FIG. 10 shows an example network environment 1900, in which various example embodiments may operate. A network cloud 1060 generally represents one or more interconnected networks, over which the systems and hosts described herein can communicate. Network cloud 1060 may include packet-based WANs (such as the Internet), private networks, wireless networks, satellite networks, cellular networks, paging networks, and the like. As FIG. 10 illustrates, various embodiments may operate in a network environment 1000 comprising one or more networking systems, such as a social networking system 1020a, a game networking system 1020b, a reward system 1020c, and one or more client systems 1030. The components of the social networking system 1020a, the game networking system 1020b, and reward system 1020c operate analogously; as such, hereinafter they may be referred to simply as the networking system 1020. The client systems 1030 are operably connected to the network cloud 1060 via a network service provider, a wireless carrier, or any other suitable means.

The networking system 1020 is a network addressable system that, in various example embodiments, comprises one or more physical servers 1022 and data stores 1024. The one or more physical servers 1022 are operably connected to computer network cloud 1060 via, by way of example, a set of routers and/or networking switches 1026. In an example embodiment, the functionality hosted by the one or more physical servers 1022 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 1022 may host functionality directed to the operations of the networking system 1020. Hereinafter servers 1022 may be referred to as server 1022, although the server 1022 may include numerous servers hosting, for example, the networking system 1020, as well as other content distribution servers, data stores, and databases. Data store 1024 may store content and data relating to, and enabling operation of, the networking system 1020 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, and the like.

Logically, data store 1024 corresponds to one or more of a variety of separate and integrated databases, such as relational databases and object-oriented databases, that maintain information as an integrated collection of logically related records or files stored on one or more physical systems. Structurally, data store 1024 may generally include one or more of a large class of data storage and management systems. In some embodiments, data store 1024 may be implemented by any suitable physical system(s) including components, such as one or more database servers, mass storage media, media library systems, storage area networks, data storage clouds, and the like. In one example embodiment, data store 1024 includes one or more servers, databases (e.g., MySQL), and/or data warehouses. Data store 1024 may include data associated with different networking system 1020 users and/or client systems 1030.

The client system 1030 is generally a computer or computing device including functionality for communicating (e.g., remotely) over a computer network. The client system 1030 may be a desktop computer, laptop computer, tablet computer, in- or out-of-car navigation system, smart phone or other cellular or mobile phone, or mobile gaming device, among other suitable computing devices. Client system 1030 may execute one or more client applications, such as a Web browser.

When a user at a client system 1030 desires to view a particular webpage (hereinafter also referred to as target structured document) hosted by the networking system 1020, the user's web browser, or other document rendering engine or suitable client application, formulates and transmits a request to the networking system 1020. The request generally includes a URL or other document identifier as well as metadata or other information. By way of example, the request may include information identifying the user, a timestamp identifying when the request was transmitted, and/or location information identifying a geographic location of the user's client system 1030 or a logical network location of the user's client system 1030.

Although the example network environment 1000 described above and illustrated in FIG. 10 is described with respect to the social networking system 1020a and the game networking system 1020b, this disclosure encompasses any suitable network environment using any suitable systems. For example, a network environment may include online media systems, online reviewing systems, online search engines, online advertising systems, or any combination of two or more such systems.

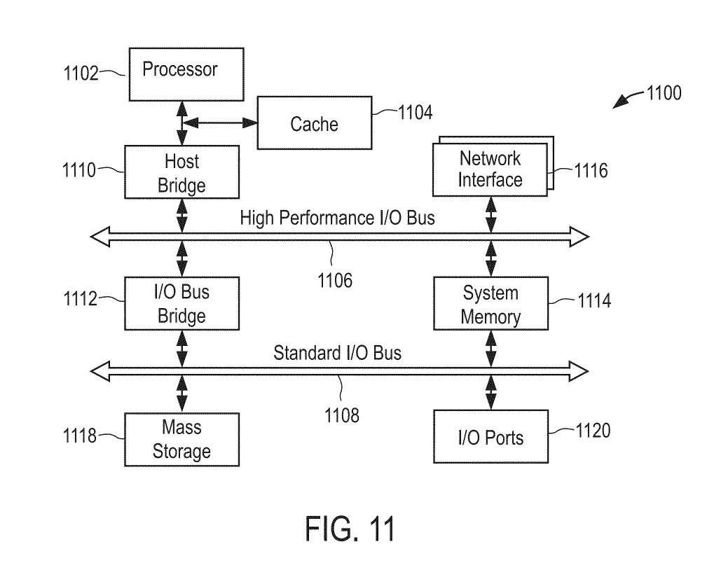

FIG. 11 illustrates an example computing system architecture, which may be used to implement a server 1022 or a client system 1030. In one embodiment, the hardware system 1100 comprises a processor 1102, a cache memory 1104, and one or more executable modules and drivers, stored on a tangible computer-readable storage medium, directed to the functions described herein. Additionally, the hardware system 1100 may include a high performance input/output (I/O) bus 1106 and a standard I/O bus 1108. A host bridge 1110 may couple the processor 1102 to the high performance I/O bus 1106, whereas the I/O bus bridge 1112 couples the two buses 1106 and 1108 to each other. A system memory 1114 and one or more network/communication interfaces 1116 may couple to the bus 1106. The hardware system 1100 may further include video memory (not shown) and a display device coupled to the video memory. Mass storage 1118 and I/O ports 1111 may couple to the bus 1108. The hardware system 1100 may optionally include a keyboard, a pointing device, and a display device (not shown) coupled to the bus 1108. Collectively, these elements are intended to represent a broad category of computer hardware systems.

The elements of the hardware system 1100 are described in greater detail below. In particular, the network interface 1116 provides communication between the hardware system 1100 and any of a wide range of networks, such as an Ethernet (e.g., IEEE 802.3) network, a backplane, or the like. The mass storage 1118 provides permanent storage for the data and programming instructions to perform the above-described functions implemented in servers 1022 of FIG. 10, whereas system memory 1114 (e.g., DRAM) provides temporary storage for the data and programming instructions when executed by the processor 1102. I/O ports 1120 are one or more serial and/or parallel communication ports that provide communication between additional peripheral devices, which may be coupled to the hardware system 1100.

The hardware system 1100 may include a variety of system architectures, and various components of the hardware system 1100 may be rearranged. For example, cache memory 1104 may be on-chip with the processor 1102. Alternatively, the cache memory 1104 and the processor 1102 may be packed together as a “processor module,” with processor 1102 being referred to as the “processor core.” Furthermore, certain embodiments of the present disclosure may neither require nor include all of the above components. For example, the peripheral devices shown coupled to the standard I/O bus 1108 may couple to the high performance I/O bus 1106. In addition, in some embodiments, only a single bus may exist, with the components of the hardware system 1100 being coupled to the single bus. Furthermore, the hardware system 1100 may include additional components, such as additional processors, storage devices, or memories.

An operating system manages and controls the operation of the hardware system 1100, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a,” “an,” or “the” is intended to mean “one or more” unless specifically indicated to the contrary. In addition, it is to be understood that functional operations, such as “awarding,” “locating,” “permitting,” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments, the term “web service” and “website” may be used interchangeably and, additionally, may refer to a custom or generalized API on a device, such as a mobile device (e.g., cellular phone, smart phone, personal GPS, personal digital assistance (PDA), personal gaming device, etc.), that makes API calls directly to a server. Still further, while the embodiments described above operate with business-related virtual objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
receiving an indication of an action performed within an online game;
identifying two or more feeds external to the online game; and
in an automated operation performed at least in part by one or more processors in response to the received indication, posting information associated with the action to the identified two or more feeds.

2. The method of claim 1, wherein identifying two or more feeds external to the online game includes selecting two or more feeds external to the online game based on the action performed within the online game.

3. The method of claim 1, wherein the identified two or more feeds external to the online game include a feed supported by a social network service that includes a player that performed the action within the online game as a member and a feed supported by a micro-blog that includes the player as a member; and
wherein posting information associated with the action to the identified two or more feeds automatically posting the information to the identified two or more feeds on behalf of the player in response to the action being performed within the online game.

4. The method of claim 1, wherein the identified two or more feeds external to the online game include a feed supported by a social network service that includes a player that performed the action within the online game as a member and a feed supported by a micro-blog that includes the player as a member; and
wherein posting information associated with the action to the identified two or more feeds includes posting the information to the identified two or more feeds on behalf of the player in response to a request received from the player to post the information to the identified two or more feeds.

5. The method of claim 1, wherein the identified two or more feeds external to the online game include a feed supported by a social network service that includes a player that performed the action within the online game as a member; and wherein posting information associated with the action to the social network service includes:
automatically generating a feed item that is configured to a specification for feed items associated with the social network service; and
automatically posting the feed item to the social network service on behalf of the player in response to the action being performed within the online game.

6. The method of claim 1, wherein the identified two or more feeds external to the online game include a feed supported by a micro-blog that includes a player that performed the action within the online game as a member; and wherein posting information associated with the action to the micro-blog includes:
automatically generating a feed item that is configured to a specification for feed items associated with the micro-blog; and
automatically posting the feed item to the micro-blog on behalf of the player in response to the action being performed within the online game.

7. The method of claim 1, wherein posting information associated with the action to the identified two or more feeds includes posting a feed item to each of the identified two or more feeds that includes a link to a user-redeemable reward within the online game.

8. The method of claim 1, wherein posting information associated with the action to the identified two or more feeds includes:
posting a first feed item that includes a link to a user-redeemable reward within the online game to a first feed that is supported by a social network service that includes a player that performed the action within the online game as a member; and
posting a second feed item that includes a link to access the online game to a second feed that is supported by a micro-blog that supported by a micro-blog that includes a player that performed the action within the online game as a member.

9. The method of claim 1, wherein posting information associated with the action to the identified two or more feeds includes:
posting a first feed item that includes a link to a first user-redeemable reward within the online game to a first feed that is supported by a social network service that includes a player that performed the action within the online game as a member, the user-redeemable reward being redeemable by a capped number of members of the social network service; and
posting a second feed item that includes a link to a second user-redeemable reward within the online game to a second feed that is supported by a micro-blog that includes a player that performed the action within the online game as a member, the user-redeemable reward being redeemable by an unlimited number of members of the micro-blog.

10. The method of claim 1, wherein posting information associated with the action to the identified two or more feeds includes:
posting a first feed item that includes a link to a first user-redeemable reward within the online game to a first feed that is supported by a social network service that includes a player that performed the action within the online game as a member; and
posting a second feed item that includes an advertisement for the online game to a second feed that is supported by a micro-blog that includes a player that performed the action within the online game as a member.

11. A system, comprising:
a game action module that is configured to receive an indication of an action performed within an online game that is associated with a player of the online game;
a feed selection module that is configured to select one or more feeds at which to post a feed item associated with the action performed within the online game;
a feed item module that is configured to generate one or more feed items that are based on the action performed within the online game; and
a posting module that is configured to cause the generated one or more feed items to be posted at the selected one or more feeds.

12. The system of claim 11, wherein the feed selection module is configured to select a feed at which to post a feed item based on a type of feed item to be posted to the feed.

13. The system of claim 11, wherein the feed selection module is configured to select a feed at which to post a feed item based on a type of action performed within the online game.

14. The system of claim 11, wherein the feed selection module is configured to select a feed at which to post a feed item based on a category of the online game within which the action was performed.

15. The system of claim 11, wherein the feed item module is configured to generate a feed item that includes information associated with online game and information associated with the player of the online game.

16. The system of claim 11, wherein the feed item module is configured to generate a feed item that includes information configured to a specification for feed items associated with a service that supports the feed.

17. The system of claim 11, wherein the feed selection module is configured to select include a feed supported by a social network service that includes a player that performed the action within the online game as a member and a feed supported by a micro-blog that includes the player as a member.

18. The system of claim 11, wherein the feed selection module is configured to select include a feed supported by a closed network of members that includes a player that performed the action within the online game as a member and a feed supported by an open network of users that includes the player as a user.

19. A computer-readable storage medium whose contents, when executed by a computing device, cause the computing device to perform operations, comprising:
receiving an indication of an action performed within an online game that is associated with a player of the online game;
selecting two or more feeds at which to post a feed item associated with the action performed within the online game;
generating a feed item that is based on the action performed within the online game; and
causing the generated feed item to be posted at the selected two or more feeds.

20. The computer-readable storage medium of claim 19, wherein generating a feed item includes generating a feed item having a configuration that is dependent on an online service that supports at least one of the selected two or more feeds.

21. The computer-readable storage medium of claim 19, wherein at least one of the selected two or more feeds is supported by a micro-blog that limits a number of characters for each feed item; and wherein generating the feed item includes generating a feed item that conforms to the character limit.

22. The computer-readable storage medium of claim 19, wherein at least one of the selected two or more feeds is supported by a video micro-blog that limits a size of video within feed items; and wherein generating the feed item includes generating a video within the feed item that conforms to the limited video size.
